(19) United States
(12) Patent Application Publication
(10) Pub. No.: US 2009/0199098 A1
(43) Pub. Date: Aug. 6, 2009

(54) APPARATUS AND METHOD FOR SERVING MULTIMEDIA CONTENTS, AND SYSTEM FOR PROVIDING MULTIMEDIA CONTENT SERVICE USING THE SAME

(75) Inventors: Ji Hyeon Kweon, Yongin-si (KR); Yong Gook Park, Yongin-si (KR); Hyun Jin Kim, Seoul (KR); Myung Hyun Yoo, Seongnam-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/260,530

(22) Filed: Oct. 29, 2008

(30) Foreign Application Priority Data
Feb. 5, 2008 (KR) 2008-11614

(51) Int. Cl. G06F 3/048

(52) U.S. Cl. 715/716

(57) ABSTRACT

An apparatus and method for serving multimedia contents and a system for providing a multimedia content service using the same, the apparatus including: a display unit to display multimedia contents and supplementary information; and a controller to control the display unit to display the supplementary information appended to a section of the multimedia contents when the section is reproduced, to retrieve a section including selected supplementary information from the multimedia contents stored in the memory when the supplementary information is selected using the input unit, to display section information of the retrieved section, and to reproduce the section corresponding to selected section information when the section information is selected using the input unit. Thus, it is possible to easily perform movement to a scene in which the user is interested and provide manipulation convenience and usability to the user.

### CROSS-REFERENCE TO RELATED APPLICATION

This application claims the benefit of Korean Patent Application No. 2008-11614, filed Feb. 5, 2008 in the Korean Intellectual Property Office, the disclosure of which is incorporated herein by reference.

### BACKGROUND OF THE INVENTION

1. Field of the Invention

Aspects of the present invention relate to an apparatus and method for serving multimedia contents and a system for providing a multimedia content service using the same, and more particularly, to an apparatus and method for serving multimedia contents that displays supplementary information associated with multimedia contents, and a system for providing a multimedia content service using the same.

2. Description of the Related Art

In general, as mass media continues to develop and multimedia contents become more diverse and widespread, the amount of media with which a person is in contact with on a daily basis has significantly increased. As the amount of multimedia contents increases, there is a demand for selectively providing data desired by a user. Research for solving this demand is ongoing.

Recent advances in information communication technology and the generating of multimedia contents has resulted in changing a multimedia content viewing method of a user from a passive viewing method to an active viewing method. Accordingly, there is a demand for appending supplementary information (such as a tag or a comment) to a specific multimedia content section (such as an impressive scene, an important scene, an actor's scene, an actress's scene, and a scene in which music is played) and allowing the supplementary information to be displayed later when multimedia contents are viewed again.

In addition, as an information service using wired/wireless ultrahigh-speed Internet continues to develop, there is a demand for receiving supplementary information that is appended to a multimedia content section of the same program by other users, in addition to supplementary information that is appended to a multimedia content section by a user.

However, as disclosed in Korean Patent Registration Publication No. 2005-105590, only tag information that is appended to multimedia data such as a moving picture or music data is retrieved and is outputted. Conventionally, since the supplementary information that is appended to the multimedia content section by the user or other users cannot be utilized, various multimedia content services cannot be provided to the user.

### SUMMARY OF THE INVENTION

Aspects of the invention to provide an apparatus and method for serving multimedia contents that displays supplementary information appended to a multimedia content section by a user or/and other users, while multimedia contents are reproduced, and a system for providing a multimedia content service using the same.

Aspects of the present invention also provide an apparatus and method for serving multimedia contents in which, when a user selects displayed supplementary information, different multimedia content sections including the selected supplementary information are retrieved and displayed such that movement to a section in which the user is interested is easily made, and a system for providing a multimedia content service using the same.

According to an aspect of the present invention, there is provided a method of serving multimedia contents, the method including: reproducing the multimedia contents; and displaying, on a reproduction screen, supplementary information appended to a section of the multimedia contents that is being reproduced.

According to another aspect of the present invention, there is provided a method of controlling a multimedia content serving apparatus that is connected, via a network, to a server for storing the multimedia contents and supplementary information appended to a section of the multimedia contents, the method including: reproducing the multimedia contents; receiving the supplementary information appended to the section from the server while the section is reproduced; and displaying the received supplementary information on a reproduction screen.

According to yet another aspect of the present invention, there is provided an apparatus for serving multimedia contents, the apparatus including: an input unit to receive a command of a user; a memory to store the multimedia contents and supplementary information appended to a section of the multimedia contents; a display unit to display the multimedia contents and the supplementary information; and a controller to control the display unit to display the supplementary information appended to the section when the section is reproduced, to retrieve a section including selected supplementary information from the multimedia contents stored in the memory when the supplementary information is selected using the input unit, to display section information of the retrieved section, and to reproduce a multimedia content section corresponding to selected section information when the section information is selected using the input unit.

According to still another aspect of the present invention, there is provided an apparatus for serving multimedia contents that is connected to a server for providing the multimedia contents and supplementary information appended to a section of the multimedia contents, the apparatus including: a display unit to display the multimedia contents and the supplementary information; an input unit to receive a command of a user; a communication unit to communicate with the server; and a controller to receive the supplementary information appended to the section from the server when the section is reproduced, to display the received supplementary information on the display unit, to receive section information of a multimedia content section including selected supplementary information from the server via the communication unit when the supplementary information is selected using the input unit, to display the received section information on the display unit, to receive a multimedia content section corresponding to selected section information from the server via the communication unit when the section information is selected using the input unit, and to reproduce the received multimedia content section on the display.

According to another aspect of the present invention, there is provided a system for providing a multimedia content service, the system including: a server to provide multimedia contents and supplementary information appended to the multimedia contents; a multimedia content serving apparatus to exchange information with the server; and a set top box to facilitate the exchange of information between the server and the multimedia content serving apparatus, wherein the multimedia content serving apparatus receives the supplementary appended to a section that is being reproduced from the server, displays the received supplementary information on a reproduction screen, receives section information of a multimedia content section including selected supplementary information from the server when the supplementary information is selected, displays the received section information on the reproduction screen, receives a multimedia content section corresponding to selected section information from the server when the section information is selected, and reproduces the received multimedia content section.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram showing the configuration of an apparatus for serving multimedia contents according to an embodiment of the present invention;

FIG. 2 is a flowchart illustrating a method for serving multimedia contents according to an embodiment of the present invention;

FIG. 3 is a view showing a screen for reproducing the multimedia contents in FIG. 2;

FIG. 4 is a view showing a screen that is displayed when a supplementary information view command is inputted in FIG. 3;

FIGS. 5 to 11 are views showing a series of screens that are displayed when a tag is selected as a supplementary information item in FIG. 3;

FIGS. 12 to 14 are views showing a series of screens that are displayed when a comment is selected as a supplementary information item in FIG. 3;

FIGS. 15 to 19 are views showing a series of screens that are displayed when a link is selected as a supplementary information item in FIG. 3;

FIG. 20 is a view showing the configuration of a system for providing a multimedia content service using an apparatus for serving multimedia contents according to another embodiment of the present invention;

FIG. 21 is a block diagram showing the configuration of a system for providing a multimedia content service using an apparatus for serving multimedia contents according to another embodiment of the present invention;

FIG. 22 is a block diagram showing the apparatus for serving the multimedia contents shown in FIG. 20; and

FIG. 23 is a flowchart illustrating a process of controlling the system for providing the multimedia content service shown in FIG. 20.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

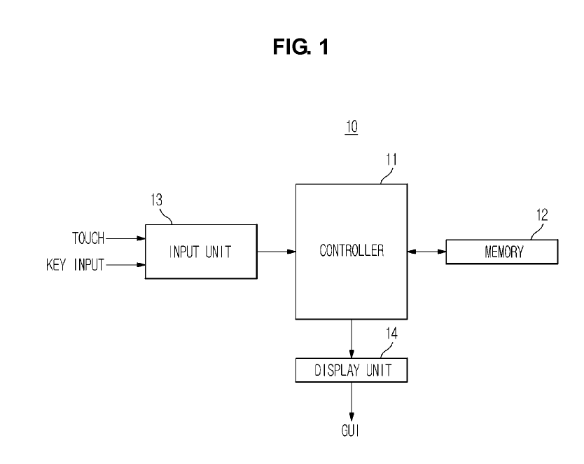

FIG. 1 is a block diagram showing the configuration of an apparatus for serving multimedia contents 10 according to an embodiment of the present invention. The apparatus for serving the multimedia contents 10 can be any device that displays and/or reproduces multimedia contents (such as a cellular phone, a personal digital assistant (PDA), a smart phone, a portable multimedia player (PMP), an electronic program guide (EPG), etc.).

Referring to FIG. 1, the apparatus for serving the multimedia contents 10 includes a controller 11 to control the reproduction of the multimedia contents and to perform various controlling operations associated therewith, a memory 12 to store the multimedia contents, an input unit 13 to receive information, and a display unit 14 to reproduce and display the multimedia contents.

The controller 11 executes a command and performs an operation associated with the command. For example, the controller 11 may control the receiving and processing of input and output data of controllable components using commands retrieved from the memory. The controller 11 may be implemented on a single chip, a plurality of chips, or an electric component. For example, various architectures such as a dedicated or embedded processor, a single-purpose processor, an application-specific integrated circuit (ASIC), etc. may be used as the controller 11. Generally, the controller 11 executes a computer code together with an operating system and performs an operation for generating and using data. The operating system, for example, may be OS/2, DOS, Unix, Linux, Palm OS etc.

The memory 12 stores computer code and data used in the multimedia content serving apparatus 10. For example, the memory 12 stores the multimedia contents or a variety of storage data appended to the multimedia content sections (such as tag information). The memory 12 may be a volatile memory (such as RAM) or a non-volatile memory (such as ROM, flash memory, or a hard disk drive).

The display unit 14 (for example, a liquid crystal display (LCD)) displays a graphical user interface (GUI) to provide an interface of an application that is being executed on the multimedia content serving apparatus 10. The GUI implements a program, a file, and/or an operation option by graphic images. The graphic image may include a window, a dialog box, a menu, an icon, a cursor, a toolbar, etc. These images may be aligned in a predetermined layout. While the GUI is operated, a user may select and activate the images in order to initiate operations associated with the various graphic images.

The input unit 13 inputs data (for example, a selection associated with the GUI on the display unit 14) to the multimedia content serving apparatus 10. The input unit 13 may include a touch sensing device that receives an input by the touch of the user and outputs information to the controller 11. For example, the input unit 13 may be a touch pad or may be combined with the display unit 14 as a touch screen. In this case, the input unit 13 recognizes a touch and a touch position on a touch sensing surface. The input unit 13 sends the touch to the controller 11 and the controller 11 analyzes the touch according to programming. Such an input unit 13 is based on a technology of sensing capacitance, resistance, a surface acoustic wave, pressure, light, etc. As described above, the input unit 13 may be a touch screen that is combined with (i.e., provided on or in front of) the display unit 14. The touch screen may be integrally formed with or separately formed from the display unit 14. The touch screen may be provided in front of the LCD such that the user directly operates the GUI.

According to other aspects, the input unit 13 may be a keypad that is provided in front of a main body of the multimedia content serving apparatus 10. The keypad may include numeral keys 0 to 9, a menu, an OK key, a “*” key, a “#” key, and navigation keys (up, down, left and right). The user presses the keypad such that a key input corresponding to a desired key is sent to the controller 11.

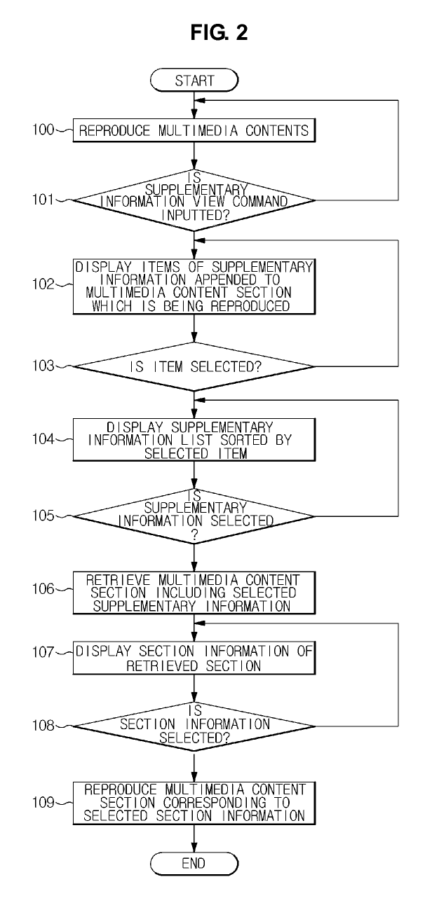

Hereinafter, the operation of the apparatus for serving the multimedia contents 10 will be described with reference to FIG. 2. FIG. 2 is a flowchart illustrating a method for serving multimedia contents according to an embodiment of the present invention. Referring to FIG. 2, the multimedia contents to be reproduced are reproduced according to a reproduction command of a user in operation 100.

When the user inputs a supplementary information view command while the multimedia contents are being reproduced (operation 101), items of supplementary information appended to a multimedia content section are displayed on a reproduction screen in operation 102.

When the user selects an item of the displayed supplementary information (operation 103), supplementary information sorted by the item selected by the user is retrieved and displayed on the reproduction screen in operation 104. Accordingly, the user can intuitively view the supplementary information appended to the multimedia content section that is being reproduced.

When the user selects desired supplementary information (operation 105), multimedia content sections including the selected supplementary information is retrieved in operation 106 and section information of the retrieved multimedia content sections is displayed on the reproduction screen in operation 107. When the user selects desired section information of the multimedia content section to be reproduced (operation 108), the multimedia content section is reproduced on the screen according to the selected section information of the multimedia content section in operation 109.

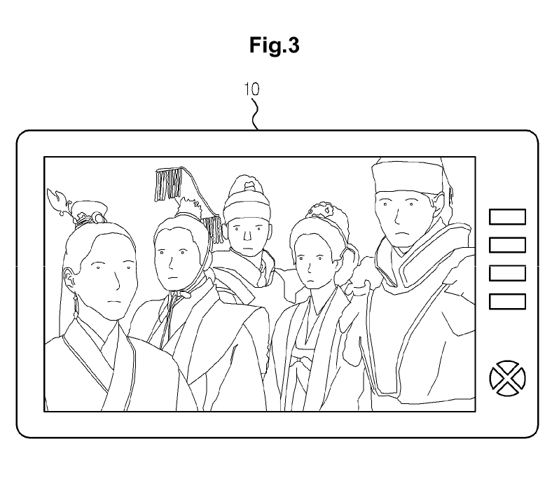

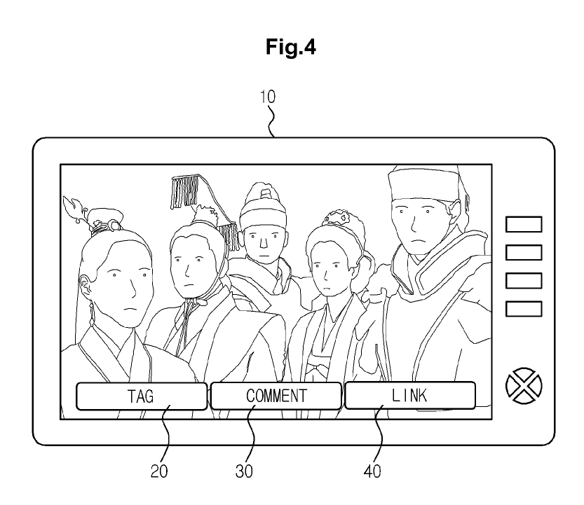

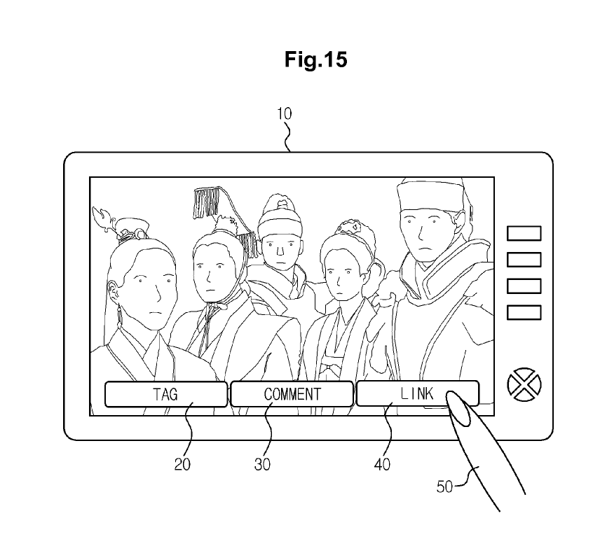

The controlling process will now be described in more detail with reference to FIGS. 3 to 19. First, when the user searches for multimedia contents to be reproduced in the menu and inputs an execution command, the multimedia contents are reproduced on the screen as shown in FIG. 3. Then, when the user inputs the supplementary information view command while the multimedia contents are being reproduced, the items of the supplementary information are displayed on the reproduction screen as shown in FIG. 4. Referring to FIG. 4, the items of the supplementary information include a tag 20, a comment 30, and a link 40, though it is understood that aspects of the present invention are not limited thereto, and these three items of supplementary information 20, 30, 40 are merely provided as an example for purposes of the present description. For example, the items of the supplementary information may additionally/alternatively include metadata. The items of the supplementary information 20, 30, 40 are displayed as the GUI elements on the reproduction screen for reproducing the multimedia contents. As illustrated, the items of the supplementary information 30, 40, 50 are horizontally arranged at the lower side of the reproduction screen. However, it is understood that according to other aspects, the items of the supplementary information 20, 30, 40 may be arranged differently (such as vertically or in a predetermined pattern). The GUI elements 30, 40, 50 are provided so as to be inputted by the touch of the user.

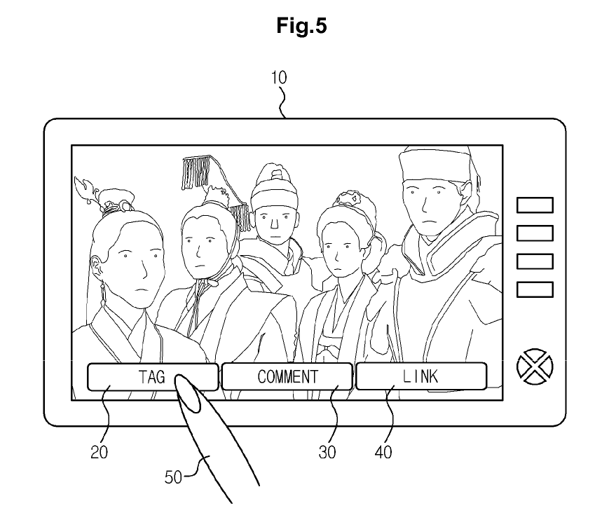

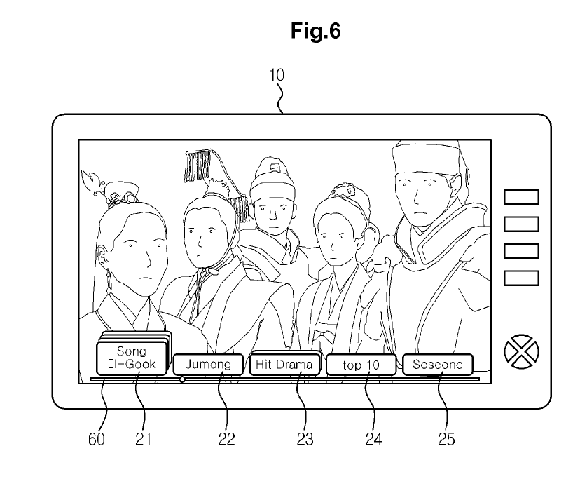

As shown in FIG. 5, if the user touches the tag 20 among the various GUI elements 20, 30, 40 with his/her finger 50 so as to select the tag 20, tag elements 21 to 25 appended to the multimedia content section that is being reproduced are retrieved and displayed on the reproduction screen as shown in FIG. 6. The tag elements 21 to 25 can be retrieved by determining whether there is supplementary information appended to the section that is being reproduced while the multimedia contents are reproduced. The tag elements 21 to 25 are displayed with respect to the section having the tag elements 21 to 25.

The tag elements 21 to 25 may be displayed at time points of a current reproduction section and start points of the multimedia content sections to which the tags are appended. That is, the tag elements 21 to 25 are sequentially displayed according to time zones (i.e., according to a reproduction time corresponding to the tag elements). For example, as the multimedia contents are reproduced, the tag elements 21 to 25 are sequentially displayed on the reproduction screen in correspondence with the multimedia content sections and all the tag elements included in the reproduction section are displayed when the multimedia content reproduction section is finished. At this time, when the tag elements are displayed with respect to the entire reproduction section, a significantly large number of tag elements may be displayed. As a result, it is difficult to search for a desired tag. Accordingly, the entire reproduction section is divided by a predetermined time (e.g., 10 minutes) and the tag elements appended to the multimedia content section are displayed in the corresponding reproduction section of the predetermined time. These tags are accumulatively displayed according to the reproduction sections.

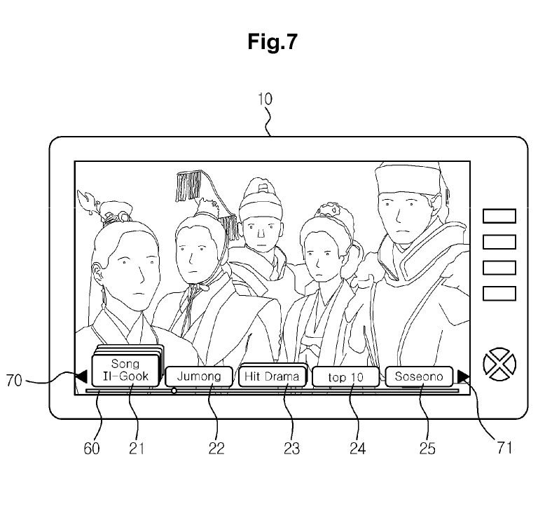

The tag elements displayed on the reproduction screen may be previously appended to specific multimedia content sections (such as an impressive scene, an important scene, an actor's scene, and a scene in which specific music is played) while the user views the same multimedia contents. Thus, the tag elements may be information associated with the multimedia content section. For example, when drama “Jumong” is viewed, a tag element “Song il-gook” 21 is tagged to a scene in which Song il-gook who is an actor of the drama “Jumong” appears, and a tag element “Soseono” 25 is tagged to a scene in which Soseono who is an actress of the drama appears (as illustrated in FIG. 7).

If the several multimedia content sections include the same tag (i.e., if several same tags are included), the GUI elements of the tag elements may be displayed so as to appear as if the tag elements are stacked such that the user can recognize that several tags are included. For example, if several same tags are included (such as the tag “Song il-gook” 21 shown in FIG. 6), only a representative tag may be displayed and the remaining tags are displayed so as to appear as if the several same tags are stacked by graphic effect.

If the number of tags is too large to simultaneously display the tags on the screen, as shown in FIG. 7, scroll buttons 70 and 71 may be provided to the left and the right sides of the tag list and the tags are sequentially moved in a left or a right direction by pressing a corresponding scroll button 70 or 71 such that all the tags can be displayed. A time line 60 representing the reproduction time of the multimedia contents may also be provided.

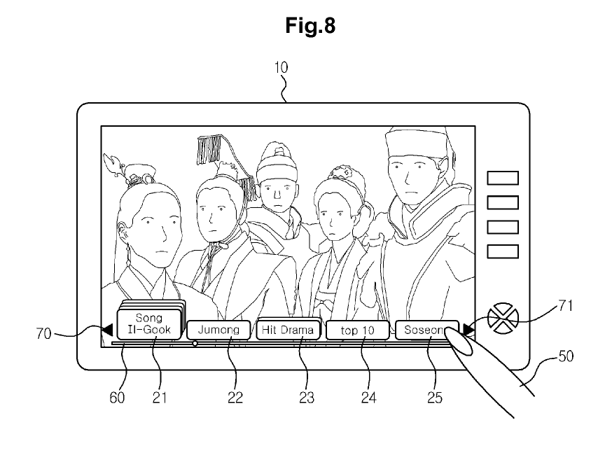

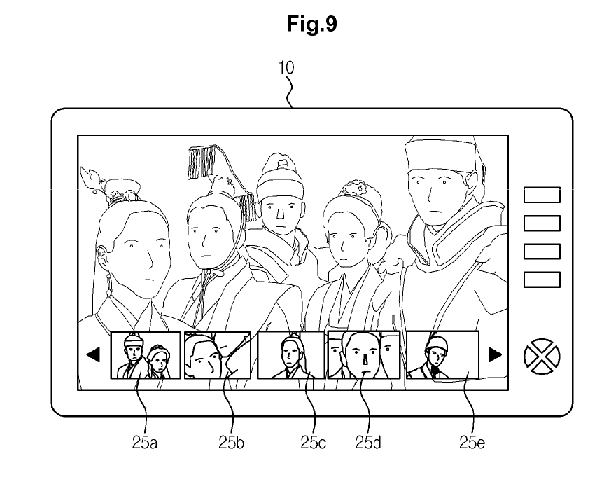

If the user selects the tag element “Soseono” 25 from the several tags 21 to 25 (as shown in FIG. 8), all of the multimedia content sections to which the “Soseono” 25 is tagged, from the entire reproduction section of the multimedia contents, are retrieved from the memory 12 and the section information 25a to 25e of the retrieved multimedia content sections are displayed on the reproduction screen (as shown in FIG. 9). The section information 25a to 25e of the retrieved multimedia content sections is summary information of the multimedia content sections and includes, for example, a thumbnail image, tag representative information, and time information of the multimedia content sections. If the section information of the retrieved multimedia content sections is displayed as thumbnail images, the thumbnail images of all the multimedia content sections including the tag element “Soseono” 25 are sequentially displayed on the reproduction screen. At this time, the thumbnail images of all the multimedia content sections including the tag element “Soseono” 25 are sequentially displayed according to time zones.

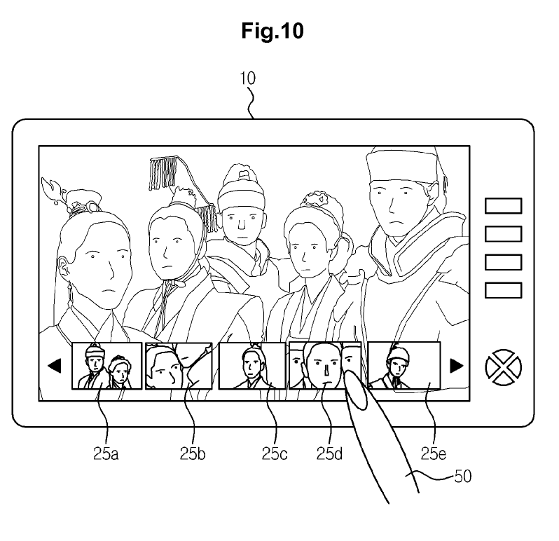

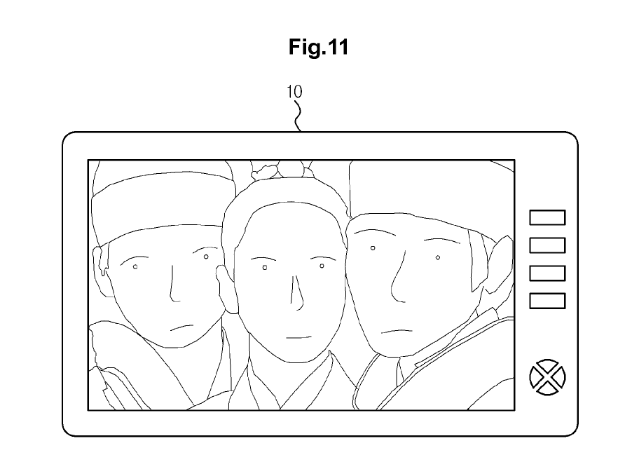

When the user selects one of the thumbnail images (as shown in FIG. 10), a multimedia content section corresponding to the selected thumbnail image is reproduced (as shown in FIG. 11). At this time, the multimedia content that was previously being reproduced is paused.

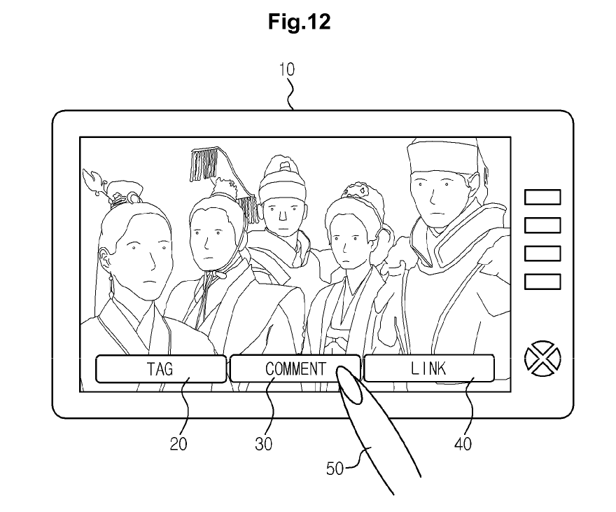

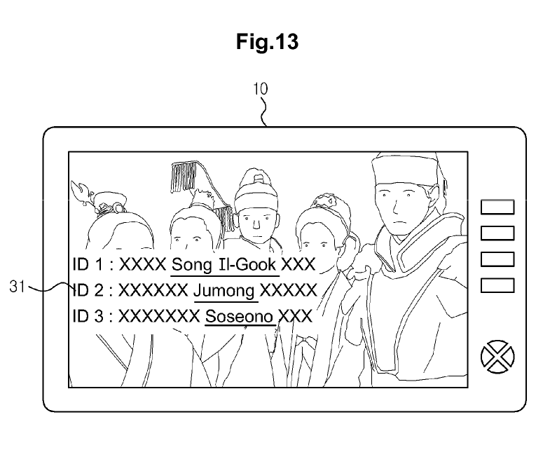

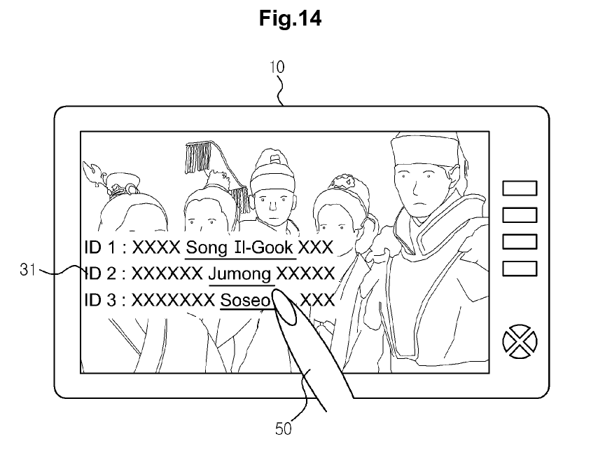

Meanwhile, when the user touches the comment 30 from among the several GUI elements 20, 30, 40 shown in FIG. 12 with his/her finger 50, the comment element 31 appended to the multimedia content section that is being reproduced is retrieved and displayed on the reproduction screen (as shown in FIG. 13). The comment element 31 may be displayed in a same manner as the tags or a different manner from the tags. For example, while the tags are horizontally arranged at the lower side of the reproduction screen, the comment may be vertically arranged on the reproduction screen. Among the words in the comment content, a word that identical (or corresponds) to a tag appended to the multimedia content section stored in the memory 12 may be recognized as the tag, and distinguished from other words so as to be available for selection by the user. For example, when the user selects “Soseono” in the comment 31 (as shown in FIG. 14), the control is performed in the same manner as when selecting the tag “Soseono.”

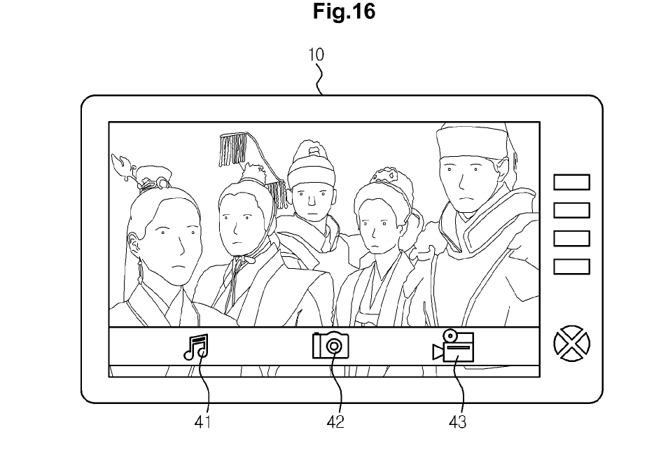

Meanwhile, when the user touches the link 40 from among the several GUI elements 20, 30, 40 with his/her finger 50, link elements 41 to 43 appended to the multimedia content section that is being reproduced are retrieved and displayed on the reproduction screen (as shown in FIG. 16). The displayed link elements 41 to 43 include a music file icon 41, a picture file icon 42, and a moving picture file icon 43. Accordingly, the link elements 41 to 43 include, for example, a moving picture file of a specific scene, a music file for a theme song inserted into a specific scene, and an image file of a shop that sells a necklace appearing in a specific scene, which is previously stored while the user views the multimedia contents.

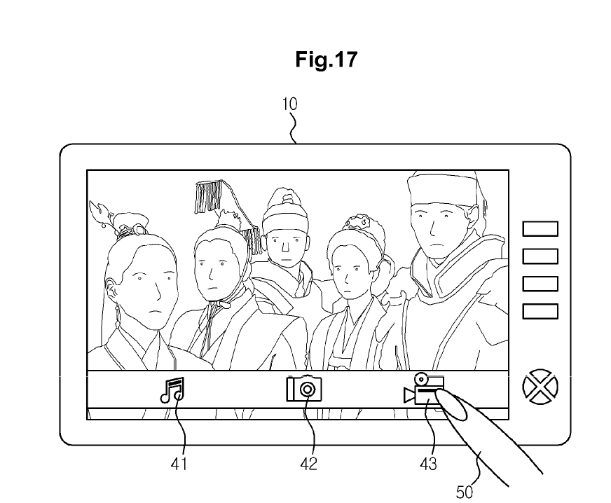

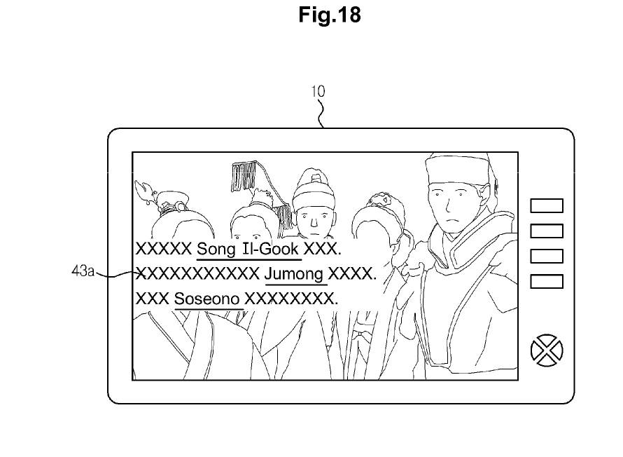

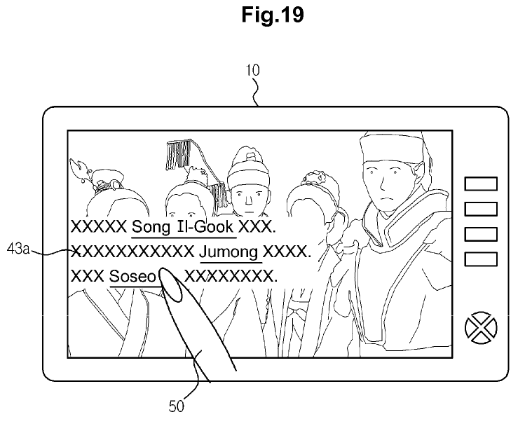

When the user selects the moving picture file icon 43 from among the link elements 41, to 43 (as shown in FIG. 17), a text 43a included in the selected moving picture file is extracted and displayed on the reproduction screen (as shown in FIG. 18). The text 43a may be displayed in the same manner as the comment 31 illustrated in FIGS. 13 and 14. Among the words in the text 43a, a word that is identical (or corresponds) to a tag appended to the multimedia content section stored in the memory 12 may be recognized as the tag, and distinguished from other words so as to be available for selection by the user. For example, when the user selects “Soseono” in the text contents (as shown in FIG. 19), the control is performed in the same manner as when selecting the tag “Soseono.”

Hereinafter, a case where many people share the supplementary information appended to the multimedia content section in the system for providing the multimedia content service including an apparatus for serving the multimedia contents according to another embodiment of the present invention will be described. As an example of a digital broadcasting environment, an Internet protocol television (IPTV) provides information services, moving picture contents, and broadcast television using ultrahigh-speed Internet. The IPTV is a type of digital convergence based on a combination of Internet and television.

In order to use the IPTV, a digital TV receiver, a set top box (STB), and an Internet cable are included. That is, when the STB and a dedicated modem are mounted in the digital TV receiver, the IPTV can be used when the digital TV receiver is turned on. Accordingly, even a person who is unfamiliar with a computer can easily receive various multimedia contents and supplementary services (such as movies, home shopping, home banking, online games, MP3s, Internet searches, etc.) using a remote controller.

The IPTV is similar to general cable broadcasting or satellite broadcasting in that multimedia contents (such as video signals) are provided, but is characterized in that bidirectionality is applied. Unlike the general cable broadcasting or satellite broadcasting, it is possible to allow the user to view a desired program at a convenient time.

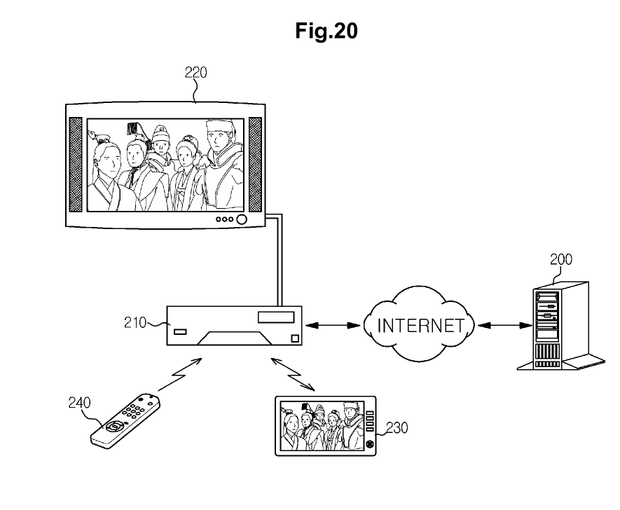

FIG. 20 is a view showing the configuration of the system for providing the multimedia content service using an apparatus for serving the multimedia contents 230 according to another embodiment of the present invention. As shown in FIG. 20, the system for providing the multimedia content service includes the multimedia content serving apparatus 230, a digital TV receiver 220 for reproducing the multimedia contents, an STB 210, and a server 200. The digital TV receiver 220 is wiredly and/or wirelessly connected to the STB 210, and the STB 210 is connected to the server 200 via, for example, the Internet.

The STB 210 sends multimedia contents provided by the server 200 to the digital TV receiver 220 such that the digital TV receiver 220 can reproduce the multimedia contents. The STB 210 may send a signal to control the digital TV receiver 220 according to information that is inputted via a remote controller 240.

The STB 210 wiredly and/or wirelessly transmits the multimedia contents provided by the server 200 to the multimedia content serving apparatus 230 according such that the multimedia content serving apparatus 230 reproduces the same multimedia contents as the multimedia contents reproduced by the digital TV receiver 220. The STB 210 and the multimedia content serving apparatus 230 are connected to each other such that bidirectional communication is possible. Thus, the STB 210 provides a command transmitted from the multimedia content serving apparatus 230 to the server 200. The multimedia content serving apparatus 230 may have a portable size and may include a touch screen by which a touch input is possible for convenience of operation of the user.

The STB 210 is connected to a multimedia content channel for receiving the multimedia contents and a return channel for a bidirectional supplementary service. A terrestrial channel, a satellite channel, and/or a cable channel may be used as the multimedia content channel and an IP-based network technology may be used as the return channel. The multimedia contents received by the STB 210 are transmitted to the multimedia content serving apparatus 230 in addition to the digital TV receiver 220 such that the multimedia contents can also be viewed by the multimedia content serving apparatus 230. The STB 210 transmits and/or receives data to/from the multimedia content serving apparatus 230 using the return channel.

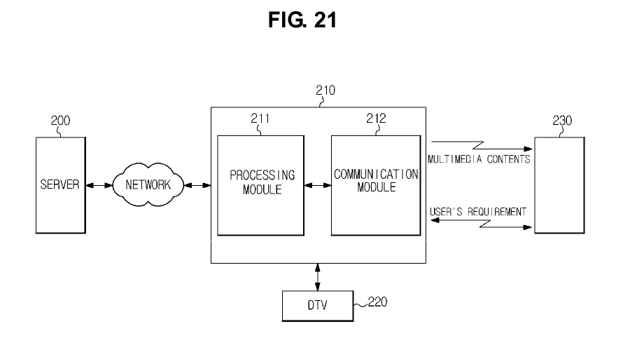

As shown in FIG. 21, the STB 210 includes a processing module 211 and a bidirectional communication module 212. The processing module receives the multimedia contents provided by the server 200 via the network (through, for example, the multimedia content channel), extracts the multimedia contents and supplementary information associated therewith, reproduces the multimedia contents, and transmits a user's requirements provided by the multimedia content serving apparatus 230 to the server 200 via the network (through, for example, the return channel). The bidirectional communication module 212 provides the multimedia contents and the supplementary information associated therewith to the multimedia content serving apparatus 230 in real time.

The STB 210 receives the multimedia contents provided by the server 200 via the multimedia content channel or transmits the response contents of the user to the server 200 using the return channel, transmits the multimedia contents and the supplementary information associated therewith to the multimedia content serving apparatus 230, and performs synchronization and linkage.

The network including the multimedia content channel and the return channel is used to transmit the multimedia contents and the supplementary information associated therewith, which are transmitted from the server 200 to the STB 210, and/or to transmit the user's requirement, which is transmitted from the STB 210 to the server 200.

The multimedia contents received via the multimedia content channel are sent to and reproduced by the multimedia content serving apparatus 230 and the digital TV receiver 220 connected to the STB 210 via the network. At this time, the multimedia contents and the supplementary information associated therewith are provided to the multimedia content serving apparatus 230 together.

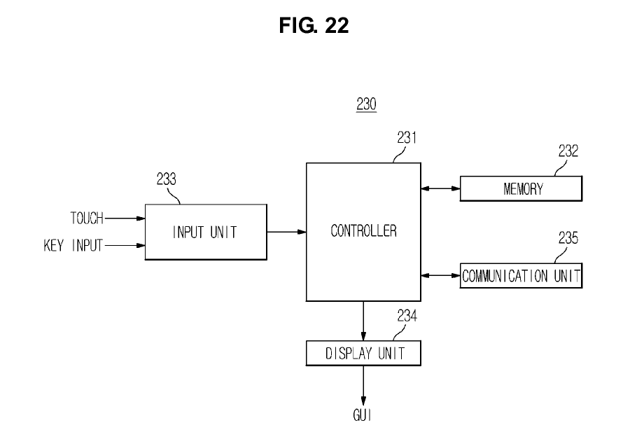

FIG. 22 is a block diagram showing the apparatus for serving the multimedia contents shown in FIG. 20. Referring to FIG. 22, the multimedia content serving apparatus 230 includes a controller 231 to control a reproduction of the multimedia contents and to perform a variety of controlling operations associated therewith, a memory 232 to store a variety of information used for the control of the controller 231, an input unit 233 to receive information from the user, a display unit 234 to reproduce and display the multimedia contents, and a communication unit 235 to communicate with the server 200 via the STB 210.

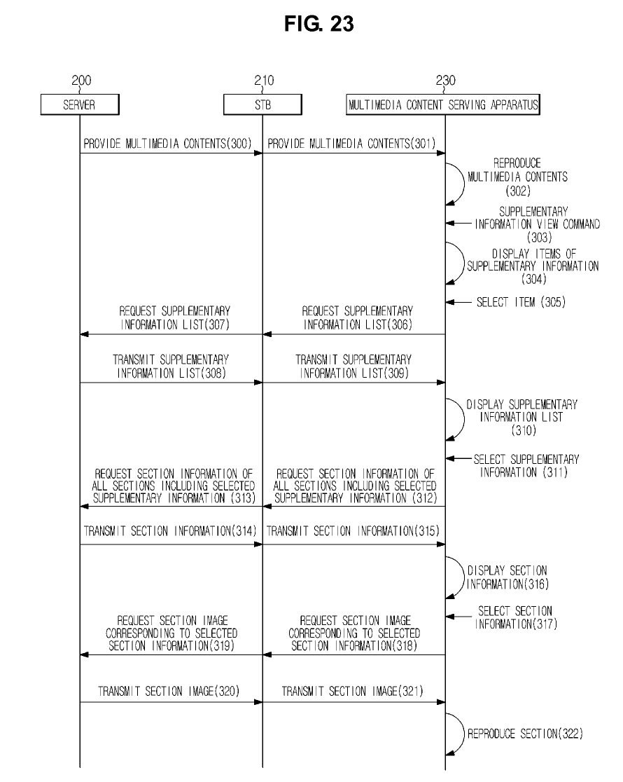

Hereinafter, an operation of the system for providing the multimedia content service will be described with reference to FIG. 23. FIG. 23 is a flowchart illustrating a process of controlling the system for providing the multimedia content service shown in FIG. 20. Referring to FIG. 23, the server 200 provides the multimedia contents to the STB 210 in operation 300 and the STB 210 provides the multimedia contents to the multimedia content serving apparatus 230 in operation 301. Accordingly, the multimedia content serving apparatus 230 receives the multimedia contents from the STB 210 and reproduces the received multimedia contents in operation 302.

When the user inputs a supplementary information view command while the multimedia contents are reproduced, the multimedia content serving apparatus 230 displays items of supplementary information that are previously stored on the reproduction screen in operation 304. At this time, the items of the supplementary information may be requested and received from the server 200 via the STB 210. In this case, the multimedia content serving apparatus 230 requests the items of the supplementary information from the server 200 via the STB 210, receives the items of the supplementary information provided by the server 200 via the STB 210, and displays the items of the supplementary information. The items of the supplementary information, for example, include a tag, a comment, and a link. The items of the supplementary information (such as the tag, the comment, and the link) are displayed on the reproduction screen for reproducing the multimedia contents as the GUI elements. As an example, the GUI elements may be horizontally arranged at the lower side of the reproduction screen, and/or such that a touch input of the user is possible.

When the items of the supplementary information are displayed and any one of the items of the supplementary information is selected by the user (operation 305), the multimedia content serving apparatus 230 requests the supplementary information list sorted by the selected item from the STB 210 in operation 306 and the STB 210 requests the supplementary information list from the server 200 in operation 307.

The server 200 transmits the supplementary information list to the STB 210 in operation 308 and the STB 210 transmits the supplementary information list to the multimedia content serving apparatus 230 in operation 309. At this time, in the server 200, the items of the supplementary information and the supplementary information list corresponding thereto can be stored in a database. The items of the supplementary information and the supplementary information list corresponding thereto allow various users to register the supplementary information appended to the multimedia content sections (such as an impressive scene, an important scene, an actor's scene, and a scene in which specific music is played) in the server 200 in advance according to the items while viewing the multimedia contents, and allow the supplementary information to be shared with other users.

The multimedia content serving apparatus 230 receives the supplementary information list selected by the user from the STB 210 and displays the received supplementary information list in operation 310. As described above, the supplementary information list is, for example, at least one tag element if the item is the tag, is the comment element including at least one tag if the item is the comment, and is the link element including at least one tag if the item is the link. As an example, the supplementary information list is displayed on the reproduction screen as the GUI elements and is horizontally arranged at the lower side of the reproduction screen. At this time, if several users repeatedly register the same supplementary information with respect to the same multimedia content section, the GUI elements are displayed to overlap one another such that the preference of the users is recognized.

When the supplementary information list is displayed and any one piece of supplementary information of the supplementary information list is selected by the user (operation 311), the multimedia content serving apparatus 230 requests the section information of all the multimedia content sections including the supplementary information selected by the user from the STB 210 in operation 312 and the STB 210 requests the section information of all the multimedia content sections including the supplementary information selected by the user from the server 200 in operation 313.

The server 200 retrieves a plurality of (for example, all of) the multimedia content sections including the supplementary information selected by the user in the entire reproduction section of the multimedia contents, which are being reproduced, from the database and transmits the section information of the retrieved multimedia content section to the STB 210 in operation 314. The STB 210 transmits the section information of the retrieved multimedia content section to the multimedia content serving apparatus 230 in operation 315.

The multimedia content serving apparatus 230 receives the section information of the multimedia content section including the supplementary information selected by the user from the STB 210 and displays the received section information on the reproduction screen in operation 316. At this time, the section information of the multimedia content section is horizontally arranged on the reproduction screen according to time zones. The section information of the multimedia content section may include a thumbnail image, a text, and/or time information of a section.

When the section information of the multimedia content section is displayed and the section information of the section that is desired to be reproduced is selected by the user (operation 317), the multimedia content serving apparatus 230 requests the image of the multimedia content section corresponding to the section information selected by the user from the STB 210 in operation 318 and the STB 210 requests the image of the multimedia content section corresponding to the section information selected by the user from the server 200 in operation 319.

The server 200 transmits the image requested by the user to the STB 210 in operation 320 and the STB 210 transmits the image to the multimedia content serving apparatus 230 in operation 321. Accordingly, the multimedia content serving apparatus 230 receives the image from the STB 210 and reproduces the received image in operation 322. At this time, the multimedia contents that were previously being reproduced are paused.

The multimedia content serving apparatus may be a digital TV receiver, although aspects of the present invention are not limited thereto. In the case of a digital TV receiver, a screen for performing the control according to the supplementary information appended to the multimedia content section is displayed on the screen of the digital TV receiver. At this time, the user can manipulate the screen displayed on the digital TV receiver using a manipulation button on the digital TV receiver or a remote controller.

Although, in the above-described embodiments, the multimedia content serving apparatus is used in the Internet TV environment, it is understood that aspects of the present invention are not limited thereto. For example, the multimedia content serving apparatus is applicable to a portable apparatus that has a wireless communication module and can wirelessly communicate with the server.

Aspects of the present invention can also be embodied as computer-readable codes on a computer-readable recording medium. Also, codes and code segments to accomplish the present invention can be easily construed by programmers skilled in the art to which the present invention pertains. The computer-readable recording medium is any data storage device that can store data which can be thereafter read by a computer system or computer code processing apparatus. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of serving multimedia contents on a multimedia player, the method comprising:
reproducing the multimedia contents on the multimedia player; and
displaying, on a reproduction screen of the multimedia player, supplementary information appended to a section of the multimedia contents that is being reproduced while the section of the multimedia contents is reproduced.

2. The method as claimed in claim 1, further comprising:
displaying one or more items of the supplementary information; and
when an item of the supplementary information is selected, displaying the supplementary information sorted by the selected item.

3. The method as claimed in claim 2, wherein the one or more items include a tag, a comment, a link, and/or metadata.

4. The method as claimed in claim 1, wherein the displaying of the supplementary information comprises displaying the supplementary information in a horizontal arrangement on the reproduction screen.

5. The method as claimed in claim 4, wherein the displaying of the supplementary information further comprises displaying the supplementary information at a predetermined position on the reproduction screen.

6. The method as claimed in claim 1, further comprising:
determining whether the supplementary information appended to the section of the multimedia contents that is being reproduced exists while the multimedia contents are being reproduced,
wherein the displaying of the supplementary information comprises displaying the supplementary information if the supplementary information is determined to exist.

7. The method as claimed in claim 1, wherein the displaying of the supplementary information comprises:
displaying first supplementary information corresponding to a first section when the first section is reproduced; and
displaying second supplementary information corresponding to a second section, subsequent to the first section, when the second section is reproduced.

8. The method as claimed in claim 1, wherein the displaying of the supplementary information further comprises displaying a plurality of pieces of same supplementary information so as to be distinguished from one piece of unique supplementary information.

9. The method as claimed in claim 8, wherein the displaying of the plurality of pieces of the same supplementary information comprises grouping and displaying the plurality of pieces of the same supplementary information.

10. The method as claimed in claim 1, wherein the displaying of the supplementary information comprises displaying the supplementary information when a reproduction time point of the multimedia contents reaches a time point of the section to which the supplementary information is appended.

11. The method as claimed in claim 1, wherein the displaying of the supplementary information comprises displaying the supplementary information at a start point when the section to which the supplementary information is appended is reproduced.

12. The method as claimed in claim 1, wherein the displaying of the supplementary information comprises displaying the supplementary information according to time zones.

13. The method as claimed in claim 1, further comprising:
when an item of the supplementary information is selected, retrieving a plurality sections including the selected item of the supplementary information from the reproduced multimedia contents; and
displaying section information for each of the plurality of retrieved sections on the reproduction screen.

14. The method as claimed in claim 13, wherein the retrieving of the plurality of sections comprises:
retrieving a section including a tag element if the selected item of the supplementary information is the tag element;
selecting a tag element included in a comment element and retrieving a section including the selected tag element if the selected item of the supplementary information is the comment element; and
selecting a tag element included in a link element and retrieving a section including the selected tag element if the selected item of the supplementary information is the link element.

15. The method as claimed in claim 13, wherein the displaying of the section information comprises displaying the section information according to time zones.

16. The method as claimed in claim 13, wherein the section information comprises a thumbnail image that represents the corresponding retrieved section, time information of the corresponding retrieved section, and/or a text that describes the corresponding retrieved section.

17. The method as claimed in claim 13, further comprising, reproducing a multimedia content section corresponding to a selected section information when the section information is selected.

18. A method of controlling a multimedia content serving apparatus that is connected, via a network, to a server storing multimedia contents and supplementary information appended to a section of the multimedia contents, the method comprising:
reproducing the multimedia contents;
requesting and receiving the supplementary information appended to the section from the server while the section of the multimedia contents is reproduced; and
displaying the received supplementary information on a reproduction screen of the multimedia content serving apparatus.

19. The method as claimed in claim 18, further comprising:
when the supplementary information is selected, requesting and receiving section information of other sections of the multimedia contents including the selected supplementary information from the server; and
displaying the received section information of on the reproduction screen.

20. The method as claimed in claim 19, further comprising:
when the section information is selected, requesting and receiving a multimedia content section corresponding to the selected section information from the sever; and
reproducing the received multimedia content section.

21. An apparatus for serving multimedia contents, the apparatus comprising:
an input unit to receive a command of a user;
a memory to store the multimedia contents and supplementary information appended to a section of the multimedia contents;
a display unit to display the multimedia contents and the supplementary information; and
a controller to control the display unit to display the supplementary information appended to the section when the section is reproduced, to retrieve a section including selected supplementary information from the multimedia contents stored in the memory when the supplementary information is selected using the input unit, to display section information of the retrieved section, and to reproduce the section corresponding to selected section information when the section information is selected using the input unit.

22. An apparatus for serving multimedia contents, that apparatus connected to a server providing the multimedia contents and supplementary information appended to a section of the multimedia contents, the apparatus comprising:
a display unit to display the multimedia contents and the supplementary information;
an input unit to receive a command of a user;
a communication unit to communicate with the server; and
a controller to receive the supplementary information appended to the section from the server when the section is reproduced, to display the received supplementary information on the display unit, to receive section information of a multimedia content section including selected supplementary information from the server via the communication unit when the supplementary information is selected using the input unit, to display the received section information on the display unit, to receive a multimedia content section corresponding to selected section information from the server via the communication unit when the section information is selected using the input unit, and to reproduce the received multimedia content section on the display.

23. A system for providing a multimedia content service, the system comprising:
a server to provide multimedia contents and supplementary information appended to the multimedia contents;
a multimedia content serving apparatus to exchange information with the server; and
a set top box to facilitate the exchange of information between the server and the multimedia content serving apparatus,
wherein the multimedia content serving apparatus receives the supplementary information appended to a section that is being reproduced from the server, displays the received supplementary information on a reproduction screen, receives section information of a multimedia content section including selected supplementary information from the server when the supplementary information is selected, displays the received section information on the reproduction screen, receives a multimedia content section corresponding to selected section information from the server when the section information is selected, and reproduces the received multimedia content section.

24. The system as claimed in claim 23, wherein the multimedia content serving apparatus is a digital television receiver.

25. The system as claimed in claim 23, wherein the multimedia content serving apparatus is an electronic program guide (EPG) providing device.
